(19) United States
(12) Patent Application Publication
(10) Pub. No.: US 2009/0089029 A1
(43) Pub. Date: Apr. 2, 2009

(54) ENHANCED EXECUTION SPEED TO IMPROVE SIMULATION PERFORMANCE

(75) Inventors: David Thayer Sturrock, Evans City, PA (US); Glenn Richardson Drake, Panama City (PA); Cory R. Crooks, Moon Township, PA (US); A. David Takus, Sewickley, PA (US); Mark Anson Glavach, Slippery Rock, PA (US); Genevieve O'Neill Kolt, Painesville, OH (US); Frank Anthony Palmieri, JR., Gibsonia, PA (US)

Correspondence Address: AMIN TUROCY & CALVIN, LLP;ATTENTION: HEATHER HOLMES, 127 Public Square, 57th Floor, Key Tower, Cleveland, OH, 44114, US

(73) Assignee: ROCKWELL AUTOMATION TECHNOLOGIES, INC., Mayfield Heights, OH (US)

(21) Appl. No.: 11/864,568

(22) Filed: Sep. 28, 2007

(51) Int. Cl. G06G 7/66

(52) U.S. Cl. 703/7

(57) ABSTRACT

Systems and methods are provided to facilitate simulation(s) of components of an industrial control system. Simulation(s) execution time can be decreased by conducting the simulation in a parallel computing platform, and coupling the simulation with an optimization component that restructures the simulation code. Such automated reconfiguration removes inhibitors for parallelism, resulting in optimized code to execute the simulation, with the ensuing reduction in execution time. Execution time can also be reduced by applying an adaptive time step during state propagations that are part of the simulation.

### TECHNICAL FIELD

The subject specification relates generally to simulation of industrial control systems, and more particularly to execution timing management to improve simulation performance.

### BACKGROUND

Simulation and modeling for automation has advanced considerably. In one instance, manufacturers employ simulation for business purposes. While some have utilized simulation to close sales with suppliers, other manufacturers employ simulation for supply chain planning. For example, if it is known how many items are produced for a given line, then it can be determined where production needs to occur and what equipment needs to drive the production while yielding confidence in the final production outcome. Entities can also predict delivery schedules from simulations. Design engineers are using simulation to alter their designs to make products easier to manufacture, whereas many companies are now creating simulations of entire plants before a plant is built or refurbished.

One recent trend is the use of simulation to train plant personnel. There are two main areas where simulation has helped in training. In one, simulation allows less skilled workers to practice and gain experience “operating” plant equipment before taking the reins in the real world. In another, simulated operation offers an accelerated form of training. For instance, input/output (I/O) simulation software provides a shortcut to training on actual equipment that may not even be available at the present time, where training materials can be created from simulated manufacturing design. Training is often considered a secondary use of simulation, but the savings it produces can be considerable nonetheless. Another recent development in simulation mirrors progress in other areas of computer technology: standardization of data. One of the trends in simulation is the ability to share data. Thus, users share data in many directions, from product design and manufacturing to robot simulation and ergonomics, for example.

Three-dimensional modeling is also gaining ground in manufacturing simulation. Three-dimensional modeling first was applied in the aerospace and automotive sectors. Often, designers model robots in 3-D, then select the location for the respective operation such as “weld” and instruct the robot to perform along those lines. As for parameters such as pressure and the robot's maneuverability, such parameters can be built into the simulation and delivered by the robot manufacturer, thus preventing a simulation from inadvertently instructing the robot to perform an operation that is beyond its capabilities. Often times the robots are controlled from one or more industrial controllers that can also be simulated.

When a company has its manufacturing process fully simulated, it becomes easier to analyze a product design and observe how well it performs in a manufacturing setting. Since the design and manufacturing are not yet “live,” there is an opportunity to turn back to the design engineer and request changes before it is cost prohibitive to do so. Such changes at the simulation stage are generally much less costly to implement than at the actual manufacturing stage. Thus, early on in the life of the product, designers can analyze the simulated manufacturing process, and adjust a given product for desired manufacturability. The ability to alter a product design prior to manufacturing in order to cause the entire process work more efficiently offers significant potential savings over the traditional design process. This process is often referred to as front-loading, where a designer can identify glitches in manufacturing through simulation and then facilitate planning on how to overcome such problems. With front-loading, products can be designed so it performs well in the manufacturing simulation which should mitigate problems in actual production thus mitigating overall system costs.

Simulation can also be implemented end-to-end, thus demonstrating how every process in a plant performs together over a designated period of time. For instance, simulation can occur from the IC (industrial controller) level up to warehouse management and other supervisory systems. One area where simulations of the entire plant are taking hold is with new plants or newly refitted plants. Before manufacturers determine what equipment they need and where it should go, they simulate the plant's entire operations. Dynamic simulation thus provides a model for a new plant to ensure the plant is designed properly.

Thus, simulation for industrial control systems offers many benefits-notably the ability to determine viability of a system before expending the resources to implement the systems. Although simulation can reduce the cost of the overall system design by helping to mitigate redesign efforts and overcome unforeseen difficulties, there is a cost in performing the simulation itself. There is a cost in learning how to use a simulation tool and coming up to speed when developing control system models for the tools. Additionally, there is a cost in the processing time it takes to execute a given simulation.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

System and methods are provided to facilitate simulation of components of an industrial control system. Simulation execution time can be decreased by conducting the simulation in a parallel computing platform; however, depending on the scenario being modeled, inhibitors for parallelism can be present in the logic of the simulation. Such logic is determined by the relationships between simulated components. In an aspect, an optimization component analyzes the logic of the model that is simulated and identifies inhibitors for parallelism. The optimization component then restructures code modules provided to a simulation component at the time of configuring a simulation scenario, aiming at mitigating said inhibitors. Optimized code(s) and model(s) to execute a simulation can result in a reduction of execution time. Additionally, execution time can be reduced by applying an adaptive time step during simulation of state propagation of devices. Active controls of components that energize and de-energize the state propagation determine whether a time step employed for model propagation is to be adapted. Time adaptation, model reorganization/optimization, as well as distributed computing can be employed concurrently to increase simulation performance.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a high level block diagram of a system that facilitates simulation in accordance with an aspect of the subject innovation.

FIG. 2 illustrates a block diagram of the architecture of a system that facilitates simulation with timing management of simulation execution.

FIG. 3 illustrates an example system for reducing simulation execution time according to an aspect of the subject innovation.

FIG. 4 is an illustration of an example embodiment for generating and/or redesigning modules according to an aspect of the subject application.

FIG. 5 illustrates a diagram of a state propagation between states A and B of a device.

FIG. 6 illustrates an example system 600 that facilitates delay of a simulation execution.

FIG. 7 presents a flowchart of a method for managing simulations of an industrial control system in accordance with an aspect of the subject specification.

FIG. 8 presents a flowchart of a method for determining computational bottlenecks associated with a simulation of an industrial control system, and parallelism and run-time acceleration/de-acceleration inhibitors according to an aspect.

FIG. 9 presents a flowchart of a method for determining parallelism inhibitors and run-time acceleration/de-acceleration inhibitors associated with the logic of a model to simulate an industrial control system in accordance with an aspect of the subject innovation.

FIG. 10 illustrates an example environment for implementing various aspects of the claimed subject matter.

FIG. 11 is a schematic block diagram of a sample-computing environment with which the subject invention can interact.

### DETAILED DESCRIPTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

It is noted that as used in this application, terms such as “component,” “module,” “model,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith.

System(s) and method(s) are provided to facilitate simulation(s) of components and processes of an industrial control system. Various strategies for enhancing simulation performance are described hereinafter. A simulation can be deployed in a distributed computing platform, wherein execution time can be decreased by exploiting several computational resources that concurrently perform the simulation. Optimization of code modules that describe a simulation model can be performed based on analysis of the logic of the simulation, as well as identifying computational bottlenecks. Execution time can also be reduced by applying an adaptive time step during state propagations that take place within the simulation. Time adaptation, model reorganization/optimization, as well as distributed computing can be employed concurrently to increase simulation performance as described in greater detail below.

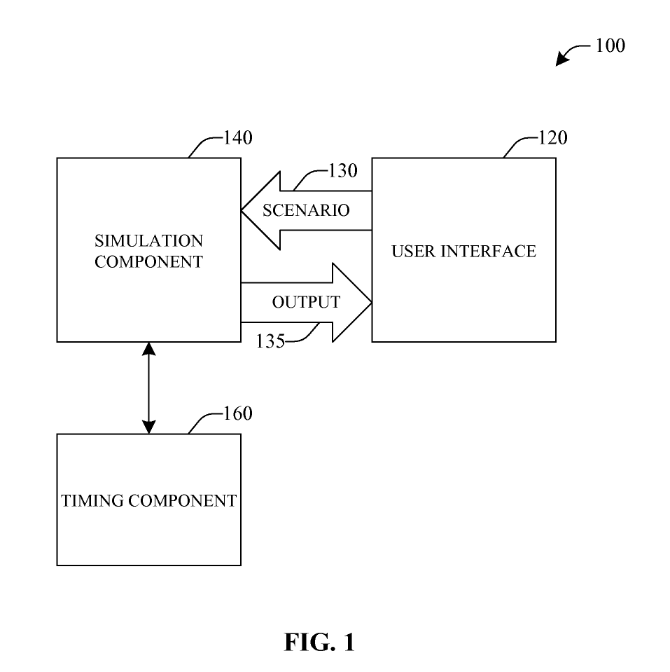

FIG. 1 illustrates a system 100 that facilitates simulation with timing management of simulation execution. A user interface 120 allows a user to characterize a scenario to be simulated. Scenarios are generic entities that typically represent an abstraction of a real world system to be simulated. In the context of the subject specification, a scenario is an industrial control system wherein a process, e.g., a manufacturing discrete processes or an industrial batch process, is carried at by a set of devices with specific capabilities according to a process protocol. Such protocol, in turn, is maintained within operational boundaries by a controller, e.g., a digital controller, a mechanical controller, or a human operator. It should be appreciated that other scenarios are formally possible, such as a solid material represented with classical inter-atomic potential models for atomic interactions and undergoing a phase transition; a solid material with a defect, where the material is idealized as a periodically repeated set of a finite number of atoms in a so-called simulation supercell that includes the defect; or yet a scenario can be a deposition process of an oxide-based or semiconductor-based device. From the examples, it is readily apparent that a scenario need not be static; time-dependent processes such as diffusion, shock waves and sound propagation, chemical reactions involving charge transfer, can be abstracted into a scenario and formally described with a variety of models such as molecular dynamics and time-dependent partial differential equations.

In industrial control processes, scenarios aim at putting forward a time dependent abstraction of the collection of devices and controllers in a particular operation condition—e.g., food processing, beverage packaging, car assembly, and so forth. In reference to FIG. 1, user interface 120 allows an operator or a client application to set up a scenario. In the case of an operator accessing user interface 120, the operator would be prompted to describe a scenario (e.g., scenario 130) by entering parameters that define the scenario, for example number of vacuum pumps in a coating chamber, number of material sources, number of electron beam guns, as well as a “recipe,” or logic describing the scenario. In industrial control systems, a process' logic can be entered to describe the “recipe.” Moreover, the operator would enter parameters such as number of devices and corresponding controllers, desired tolerance for fault timers, operational temperatures of ovens in a food processing system, and other parameters that further describe the conditions in which the process is carried out. It should be appreciated that a scenario is an abstraction of an actual system, which makes the scenario flexible. While the simplifications that may be involved in an scenario generally demand a certain degree of understanding of the industrial control system that the scenario relates to, but after a period of training an operator can exploit the flexibility that scenarios and simulations afford, particularly in scenarios dealing with unexplored conditions and relationships among its constituents (e.g., specific devices, specific controllers, specific recipes, and so on).

In the case that a client application accesses user interface 120, a scenario would normally be conveyed as output of a configuration script or even as results of a previous simulation. Such results can be stored in the simulation component or in other appropriate component.

Referring back to FIG. 1, once a scenario 130 is available, it is conveyed to a simulation component 140. Such component employs models to propagate a scenario according to model interactions among components (e.g., controllers and devices) and conditions of the scenario. Such propagation constitutes the simulation itself. A simulation elapses a period of time, which is the execution time plus configuration and communication time. It should be appreciated that the execution time can be longer or substantially equal to real-time propagation of the simulated scenario. It should be appreciated that as complexity of a model increases, execution time concurrently increases. Highly complex models can render a simulation non-viable, in particular in business development tasks, as the execution time can become longer that the time allotted to develop/evaluate a project, and it can be sufficiently long as to deplete a project's budget. It is noted that as the propagation occurs according to a model interaction, a simulation is said to model the scenario. It should be appreciated that simulation component 140 can simulate one or more components; such a distinction can be dictated by the scenario 130. Output 135 of the simulation (or the propagation) is generally conveyed to user interface 120 for analysis of in connection with the scenario and/or feedback into scenario refinements. Such output can also be stored (see below) for further processing, reporting, legacy models, etc.

Propagation typically corresponds to state transitions, and it generally is associated with time propagation. However, there are scenarios in which the propagation is in configuration space, e.g., a scenario associated with a molecule undergoing deformation due to the application of an external field. In process engineering, configuration space propagation can correspond to reassembling tools, or resources, in a production plant to attain a desired output. Still referring to FIG. 1, a timing component 160 is coupled to the simulation component 140 to increase or decrease the execution time of a simulation of the one or more components of the industrial control system. Such execution time management can be desirable in cases that execution time proves to be the bottleneck to project development; it also is desirable in the case that a plurality of scenarios are to be tested as a part of collecting statistically significant information about the scenario and its propagation under specific conditions. In contrast, delayed execution is desirable when propagation time scales are too short to be analyzed in real time, or by less experienced operators, thus requiring excessive operator time, or scripted post-processing and data mining of large files. Timing component 160 thus improves simulation performance in concert with simulation component 140 through time-related enhancements of simulation execution.

It is noted that components (simulated or real) associated with the system 100 can include various computer or network components such as servers, clients, industrial controllers (ICs), communications modules, mobile computers, wireless components, control components and so forth that are capable of interacting across a network. Similarly, the term IC as used herein can include functionality that can be shared across multiple components, systems, or networks. For example, one or more ICs can communicate and cooperate with various network devices across the network. This can include substantially any type of control, communications module, computer, I/O device, sensors, Human Machine Interface (HMI) that communicate via the network that includes control, automation, or public networks. The IC can also communicate to and control various other devices such as Input/Output modules including Analog, Digital, Programmed/Intelligent I/O modules, other programmable controllers, communications modules, sensors, output devices, and the like.

The network can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware or software components). These include components such as switches with virtual local area network (VLAN) capability, LANs, WANs, proxies, gateways, routers, firewalls, virtual private network (VPN) devices, servers, clients, computers, configuration tools, monitoring tools, or other devices.

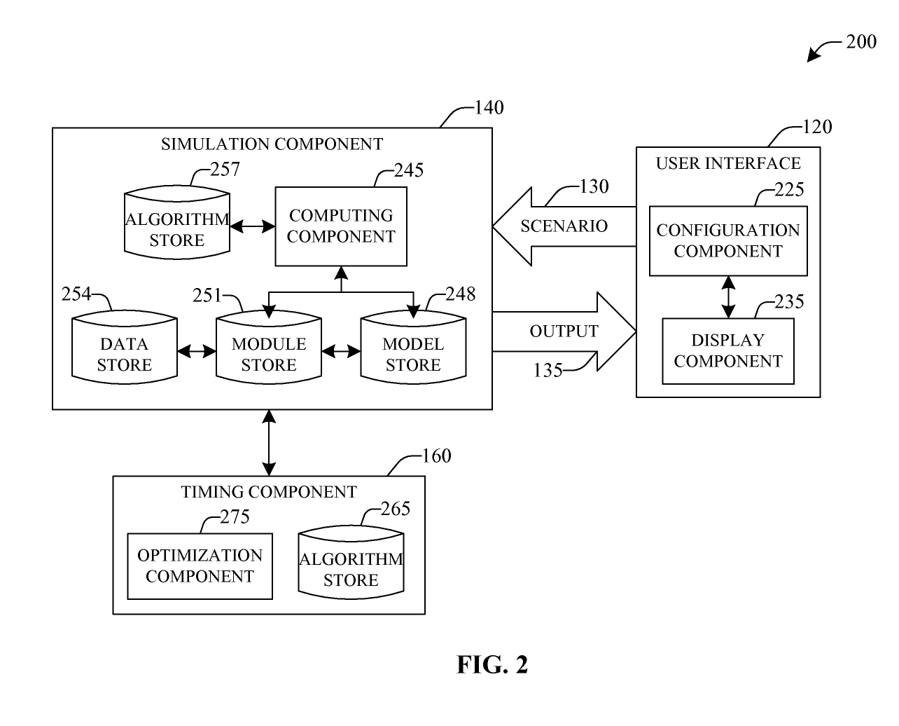

FIG. 2 illustrates a block diagram of a system 200 that facilitates simulation with timing management of simulation execution. As discussed above, a user interface 120 allows an operator or a client application to set up a scenario. Moreover, a configuration component 225 coupled to a display component 235 allows a user to (i) determine the type of simulation to be performed, e.g., a sped up or slowed down simulation, and a logic for the simulation, e.g., possible states of a device and drivers for such states, relative hierarchy, network topology of networked devices, and so forth; (ii) select the type of industrial process to be simulated (e.g., discrete process, batch, management), substances involved or products to be manufactured, as well as the type and size of facility corresponding to the process, e.g., car assembly; (iii) determine the type and number of devices, which are consistent with the process for which the scenario is being developed, and type and number of controllers; and (iv) tolerances related to operational limits, e.g., fault timers, limiting temperatures, limiting pressures. Configuration component 225 can check for logical as well as programmatic inconsistencies in the scenario, such as conflicting devices and settings limits, and so forth. When inconsistencies are identified, they can be reported in display component 235.

Display component 235 also presents the results of simulations. Depending on the simulation, display component 235 can render an animation and display graphics and parameter listings simultaneously, or sequentially, depending on user input in response to the animated results. While a simulation is executing, or computing, status data can de rendered in display component 235, to alert an operator of the level of completion of the simulation. Moreover, such display component can simulate end-user characteristics of one or more devices, one or more controllers, or any combination thereof. In this manner, which is similar to the instance in which simulation component 140 simulates the operation of a vehicle (plane, car, train, etc.), where display component 235 presents information according to the typical information a user would be provided with in such vehicle.

Simulation component 140 conducts a simulation as configured with component 225. A computing component 245 executes instructions, and generates and processes data. Data relevant to conduct the simulation (e.g., parameters describing operational limits of devices and controllers, technical specifications of said devices and controllers) and results generated by the simulation are stored in data store 254. Legacy data can also be stored in data store 254, as well as reports generated by simulation component 140 or components linked to it. In an aspect, instructions for a model of a scenario reside in a code module store 251. It should be appreciated that once simulation component 140 determines a model related a received scenario 130, the model is stored in model store 248. Models successfully employed in a simulation become legacy models, which can be used as a part of a new simulation. In particular, models are cast in terms of modules, e.g., control modules, I/O modules, fault time modules, packaging modules, that provides with functionality to simulate a specific aspect of a specific scenario (e.g., scenario 130).

The set of modules employed in a simulation depends on the relationships between the components (e.g., devices and/or controllers) to be modeled, and the logic of such relationships. As discussed above, timing component 160, in conjunction with simulation component 140, can be responsible for increasing/decreasing execution time of a simulation. To the accomplishment of that, timing component 160 employs algorithms that are stored in algorithm store 265. In an aspect, one such algorithm can be based on transforming of an actual time, or timeline, (τ) to a fictitious time, or timeline, (τ_{f}) that can be based on scaling (σ) of time steps—e.g., Δτ′=σΔτ, where σ>0 is a real number—that are employed in the time propagation of state transitions. In an aspect, scaling can be accomplished by accelerating or de-accelerating a synchronizing clock to which simulation component can be synchronized. It should be appreciated that depending on the state transition and the logic underlying the relationships between components in a scenario (e.g., scenario 130) being modeled, such time-step scaling may not be feasible as it can corrupt the logic of the simulated process.

In an aspect, in order to manage execution time and accelerate or de-accelerate a simulation, timing component 160 employs an optimization component 265 that facilitates analysis of the relationships between the one or more components (e.g., devices and/or controllers) of the scenario being modeled (e.g., an industrial control system) to infer one or more groups of components are operationally coupled. Operationally coupled components are components that take part in a specific portion of the modeled process conveyed in a scenario (e.g., scenario 130). Furthermore, the optimization component 275 can determine that one or more relationships among components (e.g., devices and controllers) being simulated, and the logic associated with the plurality of conditions describing the relationships (or interactions) among one or more of those components, are inhibitors of a run-time acceleration or de-acceleration. In particular inhibitors can prevent actual-to-fictitious time scaling transformations. In such a case, an optimization component can infer a partially restructured process intended for simulation in a specific scenario (e.g., scenario 130) in order to mitigate acceleration/de-acceleration inhibitors and afford run-time acceleration or de-acceleration of a simulation.

As used above and hereinafter, the term “infer” refers to the ability to reason or draw conclusions about the current or future conditions of a system, based on existing information about the system. Artificial intelligence (AI) can be employed to identify a specific context or action, or generate a probability distribution of specific conditions (e.g., logic in a simulated industrial process that is conductive to time scaling) of a system without human intervention. Artificial intelligence relies on applying advanced mathematical algorithms—e.g., decision trees, neural networks, regression analysis, cluster analysis, genetic algorithm, and reinforced learning—to a set of available data (information) on the system. In particular, an AI-based component, such as optimization component 275, can employ one of numerous methodologies for learning from data and then drawing inferences from the models so constructed, e.g., hidden Markov models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

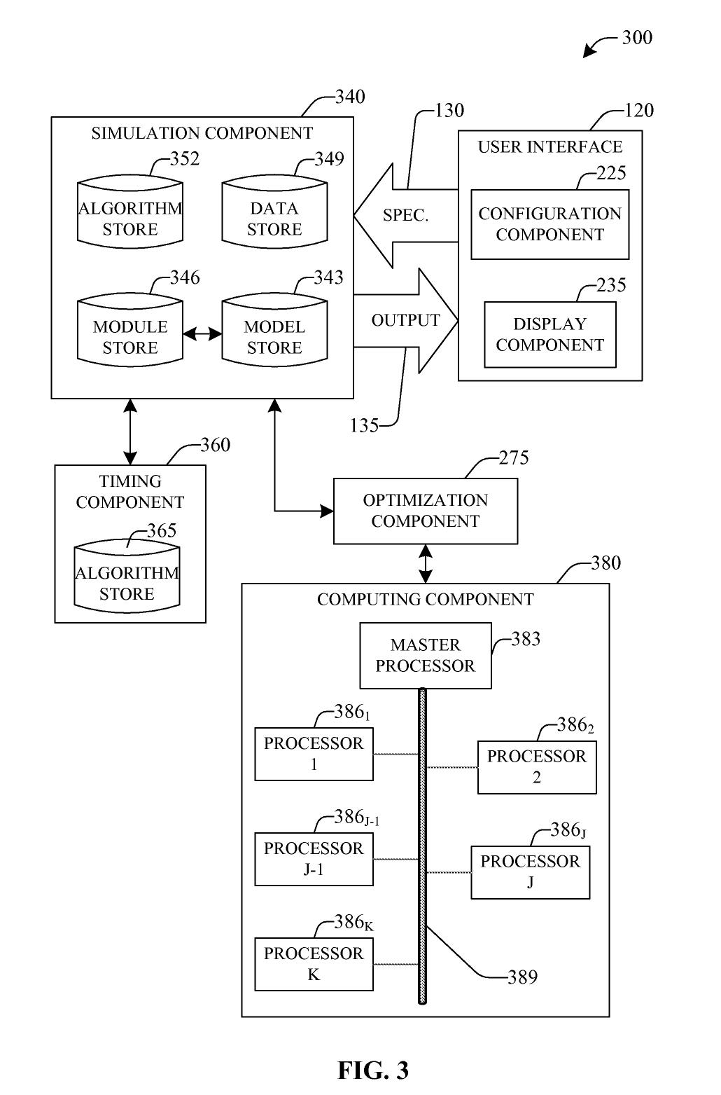

In cases time inhibitors prevent an algorithm (e.g., an algorithm store in algorithm store 265) from using a fictitious timeline to accelerate/de-accelerate execution time, a simulation can be executed in a distributed computing environment, as illustrated in FIG. 3. Moreover, distributed computing can be complemented with AI based optimization as discussed next. Simulation in a distributed environment can provide a reduced run-time by taking advantage of multiple additional distributed computing units (e.g., processors 383 and 386₁-386_{K}).

FIG. 3 illustrates an example system 300 for executing a simulation in a distributed computing platform incorporating timing management and AI based optimization. Simulation component 340 has substantially the same capabilities as simulation component 140 discussed above: a model store 343, a module store 346, a data store 349, and an algorithm store 352. Simulation component 340 accesses computing component 360 to execute the simulation. The distributed nature, and parallel utilization, of the computational resources 383 and 386₁-386_{K} afford an accelerated execution of said simulation by employing various paradigms for distributing the simulation: (a) multiple-instruction-multiple data, (b) multiple-program-multiple data, and (c) single program-multiple data. Groups of one or more computational resources can execute portion of a simulation according to one or more of paradigms (a)-(c). It is noted that a simulation in a distributed environment employ an actual timeline instead of a scaled fictitious timeline; however, it can advantageously exploit other strategies for run-time enhancement (see below). Moreover, simulation in a distributed environment demands communication and, possibly, synchronization among multiple computational resources (383 and 386₁-386_{K}). Communication is typically attained via a network bus 389 that depends on the specific architecture of computing component 360.

It should be appreciated that while a master (master processor 383)-slave (processors 386₁-386_{K}) configuration is presented in FIG. 3, other configurations for utilization of the computational resource are possible. Algorithms pertinent to such execution (such as a scheduling algorithm that allocates resources) and control of communication/synchronization among multiple computational resources 383 and 386₁-386_{K} can be stored in algorithm store 352. Simulation is based on a model of scenario 130. Legacy models as well as newly configured models (via configuration component 225) are stored in model store 343; as previously discussed, models in accordance with an aspect of the subject innovation are based on modules that provide functionality, e.g., modules are code objects with data structures and operators that represent a specific functional aspect of a scenario (e.g., scenario 130).

Simulation component 340 can also access an intermediary optimization component 275 in order to further speed up gains originating in the multiple computational resources 383 and 386₁-386_{K}. In an aspect, optimization component 275 facilitates a prototyping (simplified) simulation of one or more components of an industrial control system introduced through a scenario 130. Such a simulation can uncover a plurality of computational bottlenecks—e.g., portions of the process that require access to multiple data generated in disparate portions of the process that are executing at disparate speeds—and one or more inhibitors for parallel computing. Information gathered in a prototyping simulation can (i) be conveyed in display component 235 for a user to reconfigure the simulated process, or for verification purposes in connection with integrity of the simulation (for example, a user can configure a scenario with known computational bottlenecks and verify those bottlenecks with the ones predicted by the prototyping simulation); and (ii) be employed to restructure the distribution of tasks associated with the simulation and the available computational resources 383 and 386₁-386_{K}, in order to enhance simulation performance and effectively reduce simulation run-time. Such restructuring is carried out by optimization component 275 and, in an aspect, it consists of redesigning the set of modules employed in the simulation to attain an optimal logic in the industrial process put forward in scenario 130, or it can consist of selecting alternative modules that require less communication between tasks or exploit time management strategies available in timing component 360 (for instance, via algorithms stored in 365). The set of modules describe the operability of the components (e.g., one or more devices or one or more controllers) in the scenario. Both cases, (1) selection/redesign of modules and (2) exploitation of time management strategies, can result in accelerated simulation execution time. These cases are discussed next.

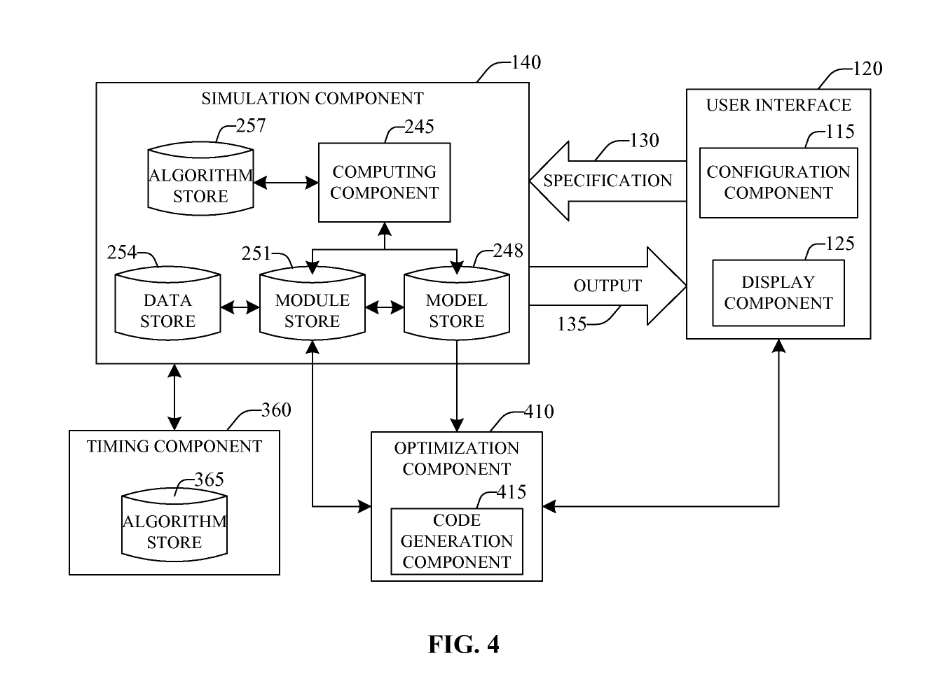

(1) It should be appreciated that selecting/redesigning modules based on prototyping simulations (termed here “module prototyping”) can entail generating new modules (or generally code), with appropriate inheritance and data structures. FIG. 4 is an illustration of an example embodiment 400 for generating and/or redesigning modules in response to a prototyping simulation executed by computing component 245. Such optimization component 410 can automatically generate such code via code generation component 415, store it in module store 343 and, in an aspect, link it to one or more models in model store 343. Code generation component 415 generates code modules upon receiving inferred module designs from optimization component 410. Such inferred designs arise in response to computation bottlenecks unveiled by simulation prototyping. In an aspect, active machine learning can be employed by optimization component 410 to infer new module designs, employing legacy modules and control prototyping simulations to generate training sets. Such automated module reconfiguration can result in optimized code to execute the simulation, with the ensuing reduction in execution time. In another aspect, optimization component can modify the (ladder) logic of an industrial controller that is simulated in scenario 130 and then can translate such redesigned logic from controller language (e.g., Verilog, assembly code) into high-level programming language (e.g., Microsoft® C#, Java, Delphi, Microsoft® Visual Basic, C++, Perl). Moreover, the modified IC logic can be deployed directly into an actual, physical IC to speed up actual, “real world” process as well. It should be noted that the module prototyping described herein can be applied for generating code beyond ICs, the generated code can simulate, and operate, physical devices like tanks, valves, motors, etc. Code generation component 410 may generate several optional modules for user evaluation and selection which can be accomplished through user interface 120. Some of those options can extend beyond the industrial process presented in scenario 130 and emphasize optimal performance capabilities for the components involved in causing the computation bottleneck in the prototyping simulation.

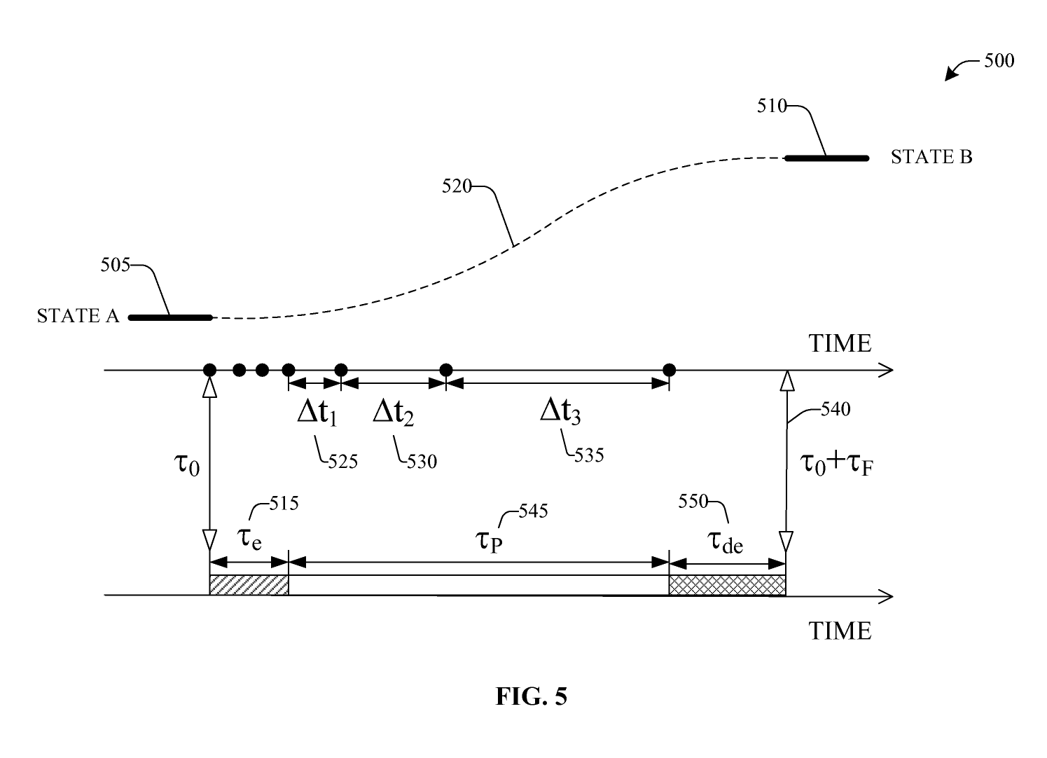

(2) In connection with strategies for time management mentioned above, an accelerated execution can arise from an adaptive time step with feedback algorithm (ATSWFA) described herein. Such algorithm is based on event driven simulations of multi-state components. ATSWFA can remove computational bottlenecks associated with state propagation that are pseudopassive. A pseudopassive state propagation can be one that requires rare, asynchronous control events. Examples of pseudopassive propagation include: filling a mixing tank or beverage container, conveyor belt transportation, paint drying stage in a car assembly line, etc. Such processes can need active control in the event a fault timer issues an alarm. Considering the case of filling a beverage container, the process need not require active control unless a dispenser issues a fault timer indicating the dispenser failed to energize or de-energy (see FIG. 5). In other words, pseudopassive propagation can be a synchronous blocking sub-process, albeit control thereof can be asynchronous. ATSWFA can exploit the pseudopassive nature of the state propagation to accelerate simulation steps as discussed below.

FIG. 5 is a diagram of state propagation between State A 505 and State B 510 of a device D (not shown). To simplify the presentation of the principle of operation of ATSWFA, and not by way of limitation, an example process is considered; namely, filling a mixing tank (e.g., device D). State A 505 can correspond to tank empty and State B 510 to tank full. It is readily apparent that in idealized conditions, filling the mixing tank will depend strictly on the fluid flux of a valve (the valve opens to fill tank; not shown) after it has been energized (τₑ 515 period of time). Thus, filling the tank need not be controlled and the pseudopassive propagation can be modeled as an instantaneous transition: Given a slope of curve AB 520 and absence of de-/energize faults, a simulation can predict deterministically the time at which propagation is complete, e.g., the tank is filled. In a real world situation, however, certain level of control is necessary to monitor the valve (a secondary component to the propagation) indeed maintains a constant flux. Yet, due to the pseudopassive nature of the propagation, control events can be spaced in time according to the feedback from the valve: If after successive control events that measure the flow passing through valve, successive values of the flow are within a tolerance (e.g., flux remains substantially the same) determined by noise introduced by different environmental factors, faulty electronics, possibly filling the tank with a stream of fluid in a turbulent regime, and other factors, a forthcoming control event can be delayed by time offset δ. If the forthcoming control event measures the same flux, a subsequent control event can be delayed by δ′, and so forth.

The information regarding lack of active control can be fed back to a simulation component (e.g., simulation component 140), which can subsequently adapt the time step Δt to reflect the absence of active control—e.g., Δt₁ 525, Δt₂ 530, and Δt₃ 535, which span the pseudopassive time span τ_{P} 540. Thus, actual number of steps (3 in case illustrated in FIG. 5) necessary to propagate the time τ_{F} 540 (which includes de-energize time τ_{de} 550) associated with changing the mixing tank from empty (State A 505) to full (State B 510) is reduced, when compared to an non-adaptive time step method, as feedback from the controller (physical or simulated) probing the valve indicates no active control is needed. It should be appreciated that ATSWFA involves active feedback from a controller and/or actual devices (physical or simulated) in order to adapt the time step of the simulation. ATSWFA can result in an accelerated simulation by shortening the simulation of pseudopassive time propagation. It should be appreciated that ATSWFA can be incorporated into timing component 160 within an Adaptive Time Step with Feedback propagation component (not shown).

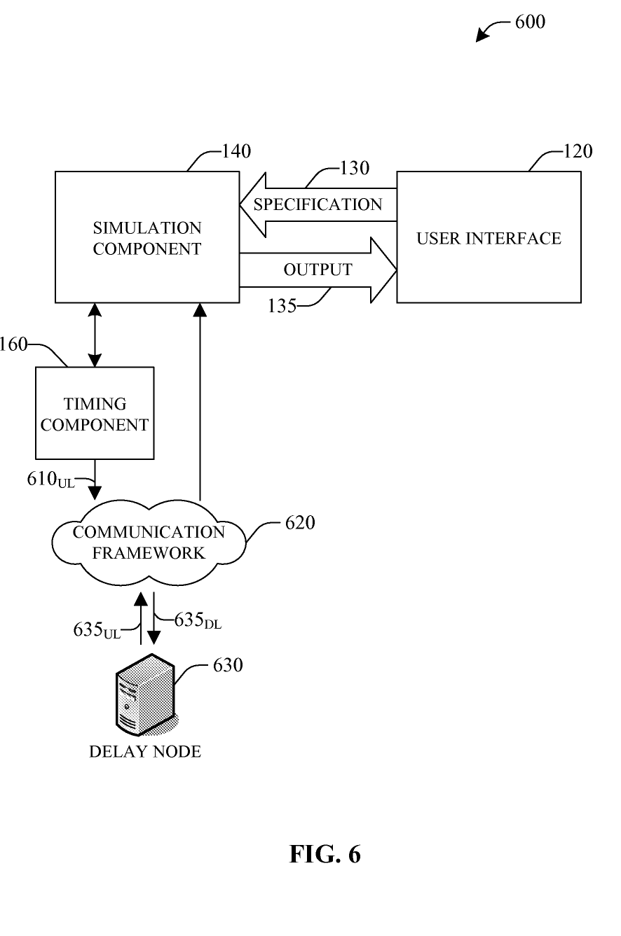

Another facet of timing management of a simulation execution is increasing execution time. FIG. 6 illustrates an example system 600 that facilitates delay of a simulation execution. System 600 operates in a substantially similar manner as system 100; namely, a user interface facilitates submission of scenario 130 (e.g., a simulation of an industrial control process, a manufacturing process, . . . ) for performing a simulation in a simulation component 140 and this component returns output 135 of the simulation to the user interface 120. A difference between system 100 and system 600 is that the latter can utilize timing component 160 to delay execution of a simulation conducted in simulation component 140. To the accomplishment of such, timing component 160 communicates a data packet over uplink 6101 of a communication framework 620 to a delay node 630 as part of executing a simulation. Delay node 630 receives the data packet over a network downlink 635_{DL}, and retransmits the data packet over uplink 635_{UL} of communication framework 620 to simulation component 140 as an indication to continue execution of the simulation. Alternatively, or in addition, timing component 160 can communicate directly with simulation component 140, rather than just simulation component 140 requesting timing component 160 the magnitude of a time delay to be applied to a simulation. In an aspect, such scenario can benefit multiple simulation components (e.g., two simulation components, a first component simulating an IC and a second component representing a physical device) needing one of the multiple components to slow down or speed up simulation run-time. As an example, on a high speed packaging line, a first simulation component simulating a physical device can benefit from a simulation of an IC to execute slower than real time, because the physical device simulation can be such that it cannot maintain a synchronized execution pace when simulating each individual packaging operation in real-time.

The advantage of employing a data-packet switched delay is that computational resources at simulation component 140 and timing component 160 are not consumed during the pause that takes place between indicating to timing component 160 to transmit a data packet. Upon the data packet returning to simulation component 140, the simulation that requested the delay can proceed. Alternatively, data packet can be communicated by simulation component 140 to delay node 630, bypassing time component 160. Communication of the data packet to delay node 630 can be asynchronous and non-blocking. Depending on the nature of the delay, e.g., length, originating instruction, and so on, data packet can be conferred intelligence and carry a set of instructions to execute in delay node 630. Such instructions can run a specific loop for a specific length of time and return to simulation component 140, but other instructions are also possible.

As an alternative to data-packet transmission for effecting a simulation execution delay, simulation component 160 can receive or acquire, from timing component 160 or a networked machine (e.g., delay node 630), a specific time delay upon initiating a simulation. For instance the time delay can be conveyed in relative terms with respect to real-time simulation execution, e.g., “run ⅕ real time.”

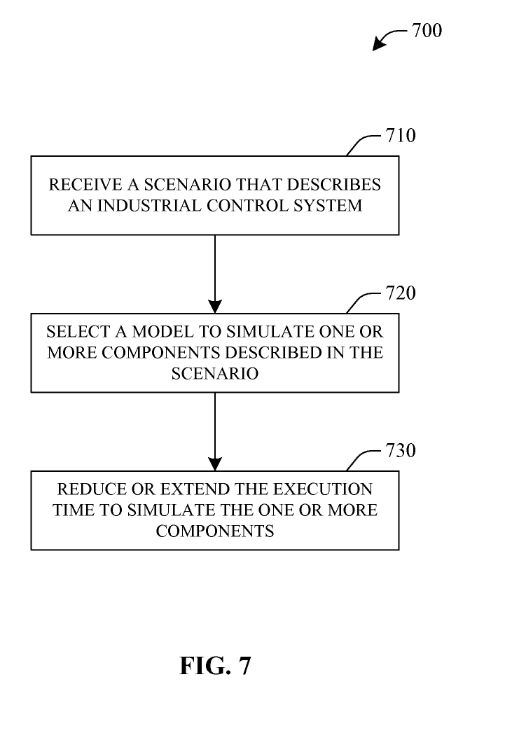

In view of the example systems shown and described above, methodologies that may be implemented in accordance with the disclosed subject matter, will be better appreciated with reference to the flowcharts of FIGS. 7 and 8, and 9. While, for purposes of simplicity of explanation, the methodologies are shown and described as a series of blocks, it is to be understood and appreciated that the claimed subject matter is not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g., device, system, process, component, . . . ). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 7 presents a flowchart of a method 700 for managing simulations of an industrial control system. At act 710, a scenario that describes an industrial control system is received. Such a scenario can be interpreted as a plurality of conditions that characterize interactions between one or more components in the industrial control system. In an aspect, interactions are dictated by an industrial process that is controlled by the system for which a scenario is received in act 710. Such interaction can be relationships between devices such as a furnace and a thermostat, or bottle filler and a bottle capper. It should be appreciated that relationships can be more complex than two-body relationships or interactions. Additionally, relationships/interactions among one or more devices and one or more controllers can be established in the industrial control system as a part of the controlled process.

At act 720, a model to simulate one or more components of the industrial control system described in the scenario is selected. Selection of a model is primarily based on the operational characteristics of the one or more components to be described and their interactions. In an aspect, code modules describe the operability of the one or more components (e.g., devices and/or controllers). In another aspect, a model is also selected so as to describe a behavior of the one or more devices, controllers, or a combination thereof. Behavior as used herein can encompass equipment (e.g., a device such as a robotic arm, or a furnace) response as part of a process controlled by the industrial control systems characterized in a scenario (e.g., scenario received at 710). Such responses include triggering alarms, setting up electric fields, controlling temperatures, igniting motors, and so on.

At act 730, execution time to simulate the one or more components being modeled is reduced or extended. Various aspects discussed in connection with FIGS. 1-6 hereinbefore can be suitable to implement such reduction of extension. Several drivers require efficient, expeditious simulation. Among those drivers are the following examples: personnel training in multiple simulated conditions within strict time constraints, business development and planning under a various assumptions, and simulation of a plurality of processes adapted to a variety of controller configurations, as well as simulation of plant/factory throughput.

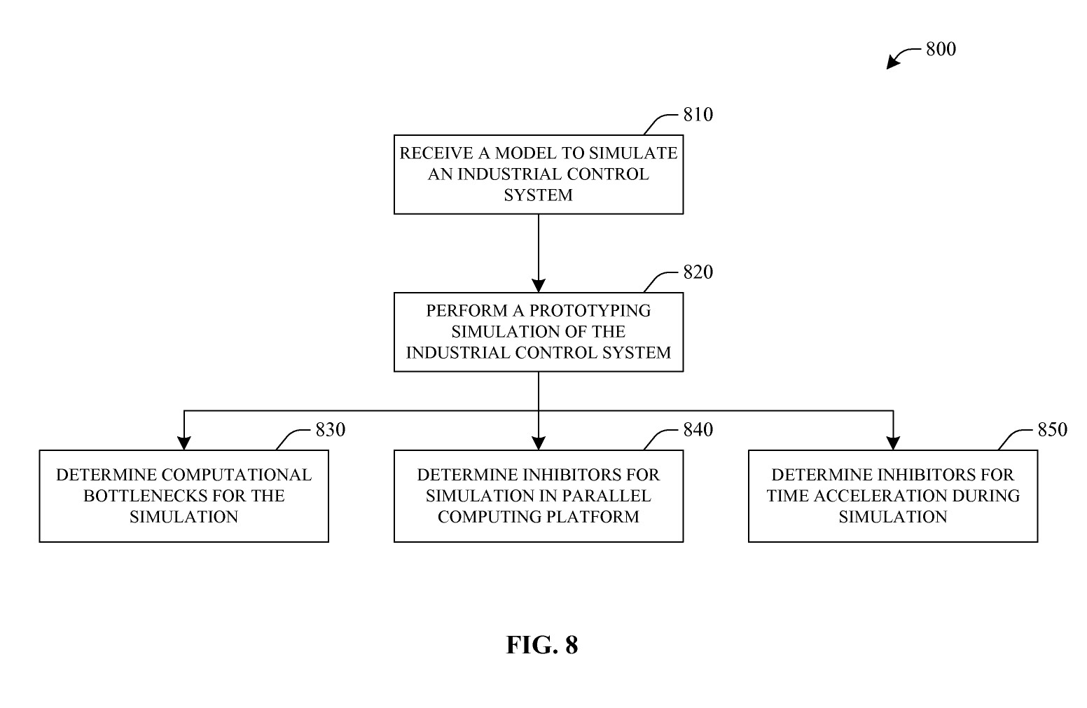

FIG. 8 presents a flowchart of a method 800 for determining computational bottlenecks associated with a simulation of an industrial control system, as well as inhibitors for applying parallel computing paradigms and time acceleration/de-acceleration as described herein. At step 810, a model to simulate the industrial control system is received. Such a model can be one of the models selected in method 700. At act, 820 a prototyping (or, informally, “warm up”) simulation is performed. It should be appreciated that several prototyping simulations can be performed in several instances of act 820. The prototyping simulation of act 820 is a simplified simulation of the industrial control system. As an example, in such a simulation alarms can be disabled, as well as granular descriptions of complex devices, such descriptions at a prototyping level of simulation is simplified with the object of capturing robust, salient aspects of the system and the computational expense of conducting simulations—control systems with predicted computational bottlenecks can be redesigned, or computationally limiting portions of the model can approached within the various aspects disclosed herein in connection with speed-up/slow-down of simulation execution times. At act 830, said computational bottlenecks are determined. Act acts 840 and 850, inhibitors—e.g., aspects of a logic in connection with a specific approach employed to simulate a scenario that indicate a simulation implementation with said approach is likely to result in poor computational performance—for parallel computing (such as strongly coupled data dependencies) and time acceleration/de-acceleration (possibly originated in strong coupling among devices and active control loops) are determined, respectively.

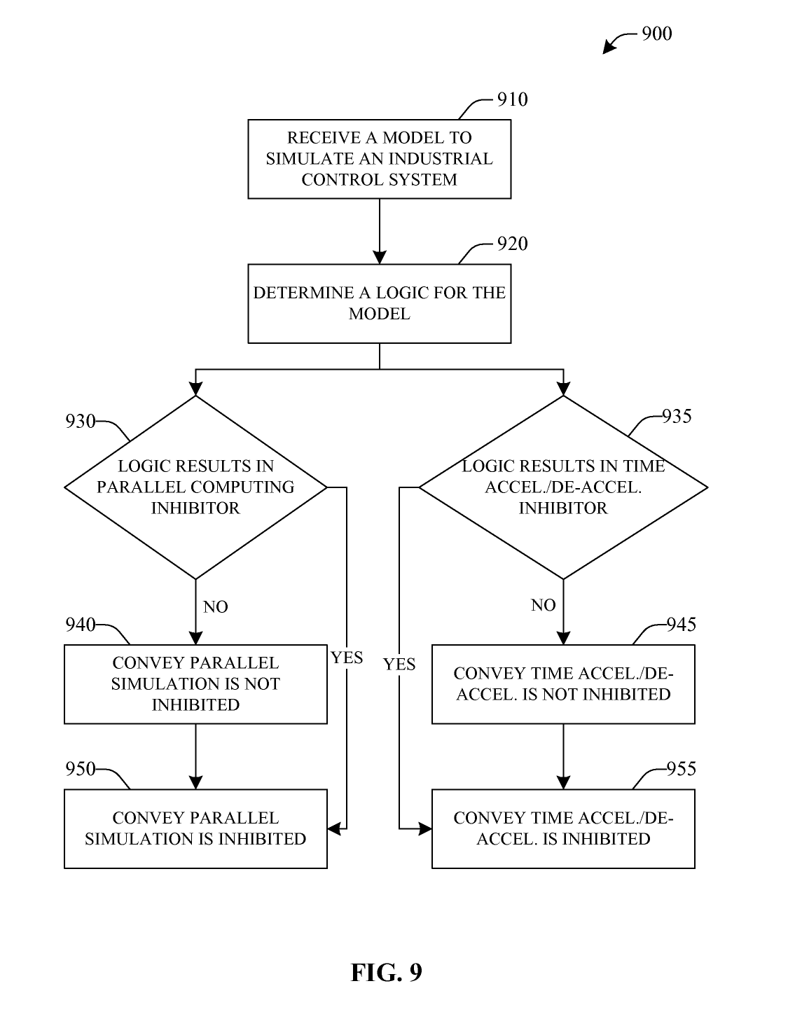

FIG. 9 presents a flowchart of a method 900 for determining inhibitors for applying parallel computing paradigms and execution time acceleration/de-acceleration associated with the logic of a model to simulate an industrial control system. At step 910, a model to simulate the industrial control system is received, and at 920 the model's logic is determined. Such determination can include tables of truth, and procedural connectivity analysis, such as identification of nested loops, conditional loops, and so forth. Acts 930 and 940 are validation checks associated, respectively, with parallelism and time acceleration/de-acceleration inhibitors. Acts 935 and 945 convey a negative instance of checks 930 and 940, respectively, whereas acts 950 and 955 convey the affirmative instance of such checks. In an aspect, conveying the results of checks 930 and 940 can be accomplished through display component 235 (FIG. 2).

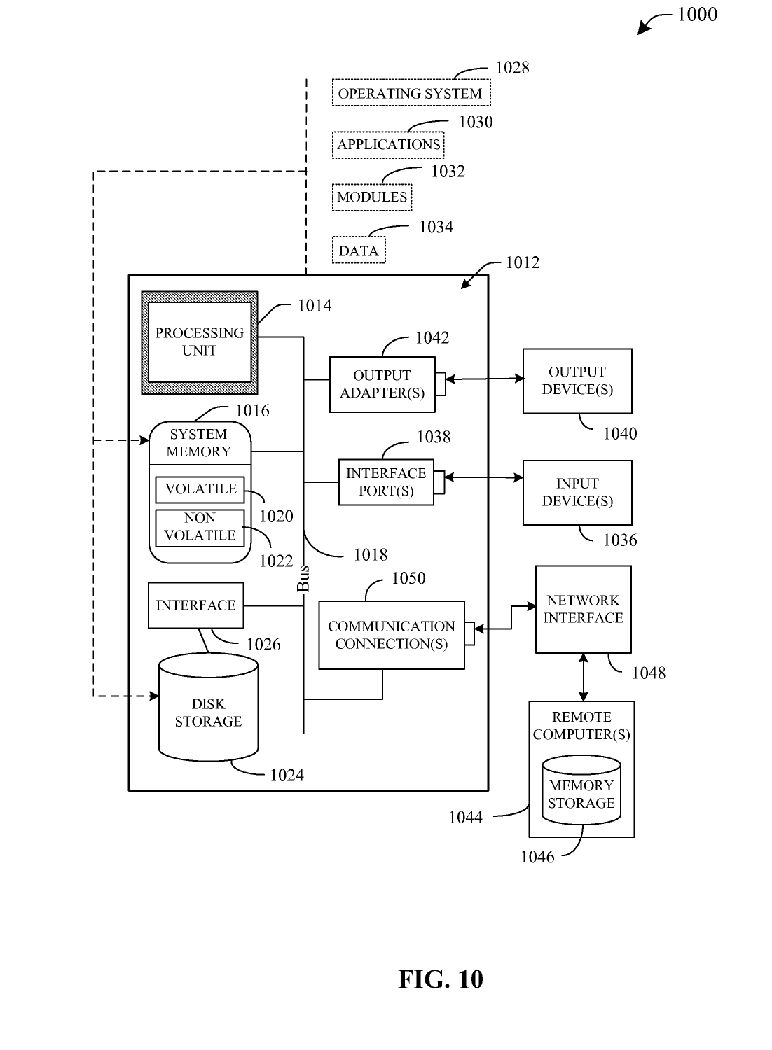

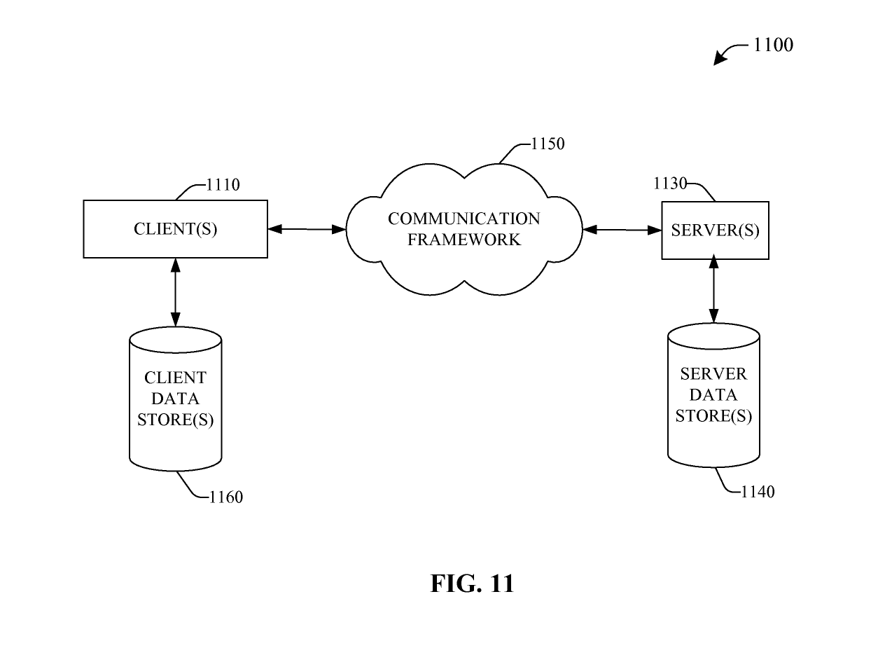

In order to provide a context for the various aspects of the disclosed subject matter, FIGS. 10 and 11 as well as the following discussion are intended to provide a brief, general description of a suitable environment in which the various aspects of the disclosed subject matter may be implemented. While the claimed subject matter has been described above in the general context of computer-executable instructions of a computer program that runs on a computer and/or computers, it can be recognized that the claimed subject matter also may be implemented in combination with other program modules. Generally, program modules include routines, programs, components, data structures, etc. that perform particular tasks and/or implement particular abstract data types. Moreover, it can be appreciated that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. In a distributed computing environment, program modules may be located in both local and remote memory storage devices.

With reference to FIG. 10, an exemplary environment 1010 for implementing various aspects of the claimed subject matter includes a computer 1012. The computer 1112 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable PROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example, a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the subject invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the subject invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . optical disks [e.g., compact disk (CD), digital versatile disk (DVD) . . . ], smart cards, and flash memory devices (e.g., card, stick, key drive . . . ).

Moreover, as used in the subject application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to facilitate simulation in an industrial control environment, comprising:
a simulation component to model one or more components of an industrial control system; and
a timing component that is coupled to the simulation component to increase or decrease the execution time of a simulation.

2. The system of claim 1, the simulation component further comprising a component that stores modules to perform the simulation of the one or more components of the industrial control system.

3. The system of claim 1, further comprising a configuration component that conveys one or more conditions that describe relationships between the one or more components of the industrial control system.

4. The system of claim 3, further comprising an optimization component that facilitates analysis of the relationships between the one or more components of the industrial control system to infer one or more groups of components that are operationally coupled.

5. The system of claim 4, wherein the operationally coupled components are modeled within a distributed computing platform.

6. The system of claim 4, the optimization component facilitates a prototyping simulation of the one or more components of the industrial control system to determine a plurality of computational bottlenecks and one or more inhibitors for parallel computing.

7. The system of claim 4, the optimization component determines whether a relationship among the one or more components of the industrial control system is an inhibitor of a run-time acceleration or de-acceleration.

8. The system of claim 1, the timing component includes an adaptive-time-step-with-feedback propagation component to speed up execution time.

9. The system of claim 8, further comprising a component that receives an asynchronous transmission, without blocking, of a data packet to slow down the simulation of the one or more components of the industrial control system.

10. A method for managing simulations of an industrial control system, the method comprising:
receiving a plurality of conditions describing the interactions between one or more devices and one or more controllers;
selecting a model for simulating a behavior of the one or more devices or the one or more controllers; and
reducing or extending the computation time for simulating the behavior of the one or more devices or the one or more controllers.

11. The method of claim 10, reducing the computation time for simulating the behavior of the one or more devices or the one or more controllers, further comprising performing a simulation in a distributed computing platform.

12. The method of claim 11, performing the simulation includes configuring the simulation within a multiple-program-multiple-data distribution paradigm.

13. The method of claim 10, further comprising performing a prototyping simulation of the one or more devices or one or more controllers, to determine a plurality of computational bottlenecks and one or more inhibitors for parallel computing and time acceleration.

14. The method of claim 10, further comprising determining a logic of the plurality of conditions describing the interaction between one or more devices and one or more controllers, and further determining from the logic whether a parallel computing inhibitor or time acceleration inhibitor exists.

15. The method of claim 10, further comprising adapting a time step for speeding up the simulation of the behavior of the one or mode devices or the one or more controllers.

16. The method of claim 10, further comprising simulating the selected model via a set of modules describing the operability of the one or more devices or the one or more controllers, the set of modules selected through a prototyping simulation.

17. An apparatus that operates in an industrial environment, the apparatus comprising:
means for accessing one or more computational resources for simulating a component in an automated control system;
means for simulating the component in the automated control system; and
means for adjusting the execution time of the simulation.

18. The apparatus of claim 17, wherein means for adjusting the execution time of the simulation includes means for shortening or lengthening the execution time.

19. The apparatus of claim 18, wherein means for shortening the execution time further comprises means for performing a distributed computation in a parallel computing platform.

20. The apparatus of claim 18, wherein means for lengthening the execution time further comprises means for transmitting and receiving a data packet.

21. A computer-readable medium having instructions stored thereon that, when executed by one or more processors, cause a computer to carry out the following acts:
setting up a computational model of a plurality of components in an industrial automation system;
simulating the plurality of components in the industrial automation system according to the computational model;
increasing or decreasing the run-time of the simulation of the plurality of components in the industrial automation system; and
storing results of the simulation of the plurality of components in the industrial automation system, and the computational model.
